(19) United States
(12) Patent Application Publication
(10) Pub. No.: US 2024/0402709 A1
(43) Pub. Date: Dec. 5, 2024

(54) OPTIMAL FLEET COMPOSITION AND DEPLOYMENT TOOL FOR AUTONOMOUS MOBILE ROBOTS

(71) Applicant: Ford Global Technologies, LLC, Dearborn, MI (US)

(72) Inventors: Mithun Goutham, Columbus, OH (US); Stephanie Stockar, Columbus, OH (US); Meghna Menon, Ann Arbor, MI (US); Sarah Garrow, Coral Gables, FL (US); Mario Anthony Santillo, Canton, MI (US)

(73) Assignee: Ford Global Technologies, LLC, Dearborn, MI (US)

(21) Appl. No.: 18/328,577

(22) Filed: Jun. 2, 2023

(51) Int. Cl. G05D 1/02

(52) U.S. Cl. CPC G05D 1/0291

(57) ABSTRACT

A method of managing a fleet of robots for delivery of materials in a facility is provided. The method includes: determining a sequence of waypoints by a Branch and Bound (B&B) method; determining a path through the sequence of waypoints by a dual graph method; determining distribution of tasks among the robots by the B&B method; and determining a fleet composition by the B&B method.

### FIELD

The present disclosure relates to systems and methods for managing delivery of materials in an automated facility, and more particularly to systems and methods for managing delivery of materials by a fleet of robots in an automated facility.

### BACKGROUND

The statements in this section merely provide background information related to the present disclosure and may not constitute prior art.

Autonomous mobile robots (AMR) have been used in a production line to deliver materials to different task stations. Fleets of robots are typically used to pick up and drop off materials among different locations in a factory or a warehouse. The robots may be multi-load robots that can simultaneously pick up and drop off multiple items at multiple locations in one single mission. Once a mission is assigned with an ordered list of pickup and drop-off locations, the fleet of robots autonomously navigate through the pickup and drop-off locations in a prescribed order.

The material flow throughput of a facility depends on the path of the robots navigating through these pickup and drop-off locations. The material flow throughput can be enhanced by reducing the time spent on travelling, turning, waiting and down time of the robots. When multi-load robots are used, path planning for the fleets of robots becomes more complicated. Moreover, the material flow throughput of a facility also depends on the fleet composition including the size of the fleet and the types of AMRs in the fleet.

The issues relating to using AMRs to handle delivery of materials in an automated facility, particularly path planning of the AMRs, the fleet composition, and the task distribution among the AMRs are addressed in the present disclosure.

### SUMMARY

This section provides a general summary of the disclosure and is not a comprehensive disclosure of its full scope or all of its features.

In one form, a method of managing a fleet of robots for delivery of materials in a facility is provided. The method includes: determining a sequence of waypoints by a Branch and Bound (B&B) method; determining a path through the sequence of waypoints by a dual graph method; determining distribution of tasks among the robots by the B&B method; and determining a fleet composition by the B&B method.

In other features, the method further includes determining a small candidate fleet composition having the most efficient fleet composition by using an increment to stagnation method. The determining a path through the sequence of waypoints includes determining a total path cost of the path. The total path cost includes a traversal cost and a pivoting cost. The traversal cost is a cost relating to translational movement of the fleet of robots. The pivoting cost is a cost relating to changing direction of the robots and time spent on changing direction. The determining a path through the sequence of waypoints includes selecting a path that has the least total path cost. The determining a sequence of waypoints includes determining movement constraints. The determining distribution of tasks among the robots includes partitioning a search space for the assignment of tasks by using a plurality of processors. The fleet composition includes a number of robots and types of robots in the fleet. The fleet or robots include a plurality of autonomous mobile robots (AMRs).

In still other features, the method further includes determining the sequence of the waypoints by considering staggered three waypoints at a time. The waypoints include pickup locations and drop-off locations where the robots pick up and drop off items, respectively.

In another form, a method of managing a fleet of robots for delivery of materials in a facility is provide. The method includes: determining a sequence of waypoints by a Branch and Bound (B&B) method based on movement constraints; determining a path through the sequence of waypoints by a dual graph method based on a total path cost; determining distribution of tasks among the robots by the B&B method; and determining a fleet composition by the B&B method.

In other features, the method further includes determining the sequence of the waypoints by considering three staggered waypoints at a time, and partitioning a search space for the assignment of tasks by using a plurality of processors. The fleet composition includes a number of the robots and types of robots in the fleet. The fleet or robots include a plurality of autonomous mobile robots (AMRs). The determining a path through the waypoints based on a dual graph further comprises selecting a path that has the least total path cost. The waypoints include pickup locations and drop-off locations where the robots pick up and drop off items, respectively.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of a fleet management system in accordance with the teachings of the present disclosure;

FIG. 2 is a schematic diagram of a layout of an automated facility;

FIG. 3 is a schematic diagram of two possible paths for a robot tasked with moving some item from one waypoint to another;

FIG. 4 is a dual graph representation of the paths of FIG. 3;

FIG. 5 is a schematic diagram of an optimal path for a robot navigating through ten waypoints when two consecutive waypoints are considered at a time for path planning;

FIG. 6 is a schematic diagram of an optimal path for a robot navigating through ten waypoints when an entire sequence of waypoints or staggered three waypoints are considered at a time for path planning;

FIG. 7 is a schematic diagram of four waypoints with constraints on the sequence of the waypoints, wherein points (a) and (c) are pickup locations, and points (b) and (d) are corresponding drop-off locations;

FIG. 8 is a tree diagram illustrating all possible paths for a robot navigating through the four waypoints of FIG. 7, based on a Branch and Bound algorithm;

FIG. 9 is a schematic diagram showing how tasks are partitioned and assigned to each robot;

FIG. 10 is a tree diagram illustrating all possible assignment of tasks to the plurality of robots based on the Branch and Bound algorithm;

FIG. 11 is a tree diagram similar to that of FIG. 10, showing a parallel implementation of the Branch and Bound algorithm regarding the assignment of tasks to the plurality of robots;

FIG. 12 is a diagram showing how the increment to stagnation algorithm is used to determine an optimal fleet size and composition; and

FIG. 13 is a method of managing a fleet of robots navigating through a plurality of waypoints in a nested optimization structure in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

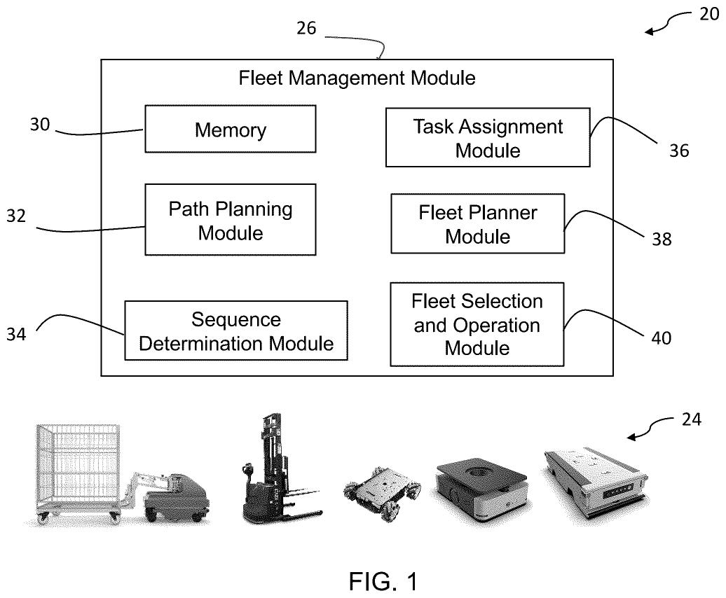

Referring to FIG. 1, a fleet management system 20 for managing delivery of materials in a facility in accordance with the teachings of the present disclosure includes a fleet of robots 24 configured to autonomously deliver materials from and to various locations of the facility and a fleet management module 26 configured to manage and control delivery of materials by the fleet of robots 24 in the facility.

The flee management module 26 includes a memory 30, a path planning module 32, a sequence determination module 34, a task assignment module 36, a fleet planner module 38, and a fleet selection and operation module 40. The memory 40 is configured to store information of a layout of the facility, constraints on movement of the robots, and the types of the robots in the fleet of robots 24. The movement constraints refer to factors that affect the planning of the movement of the robots in the facility, such as the time windows of each pickup or drop-off locations, the state of charge (SOC) of the batteries of the robots, and a required order between the pickup and drop-off locations. The fleet of robots 24 includes autonomous mobile robots (AMR) that can travel autonomously to various locations in the facility according to a prescribed path. The robots may be any available models, and may of the same type, different types, or a combination of any available models. For example, the fleet of robots may include two of one type and four of another type. The robots shown in FIG. 1 are only for illustrative purposes and the solution proposed in this application is not limited to the robots shown in FIG. 1. Each robot may be configured to pick up multiple items from multiple pickup locations and to drop off multiple items at multiple drop-off locations.

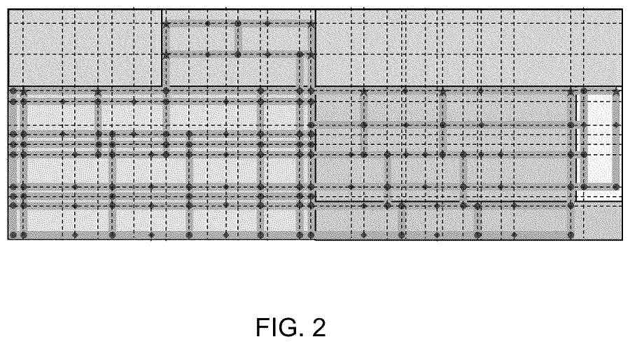

Referring to FIG. 2, the facility may be a factory 22 in which products, such as vehicles, are manufactured. Shaded regions represent various features of the factory layout that may include inventory holding locations, specialized work stations and robot charging or idling bays. The robots are responsible for the movement of material between the different regions. They are permitted to travel along the pathways that connect the different shaded regions.

The pathways available for the fleet of robots 24 may be represented by a graph of nodes that discretizes the pathways of the fleet of robots 24 into a plurality of nodes. Nodes represent physical locations of the intersections of pathways and material handling locations of interest, namely the pickup and drop-off locations for the items to be transported by the fleet of robots 24.

The path planning module 32 is configured to determine the total path costs for all possible paths by using the dual graph method in order to identify the path of least cost (i.e., the most efficient path) to be taken by a robot that must navigate through a defined sequence of waypoints. Waypoints are material-handling nodes and are restricted to the pickup and drop-off locations where the fleet of robots 24 pick up and drop off items, respectively. The total path cost includes a traversal cost and a pivoting cost (or a turn cost, a vertex cost). Traversal costs refer to the costs associated with translational movement between consecutive waypoints. The pivoting costs refer to the costs associated with turning of the robots to change a travel direction of the robots.

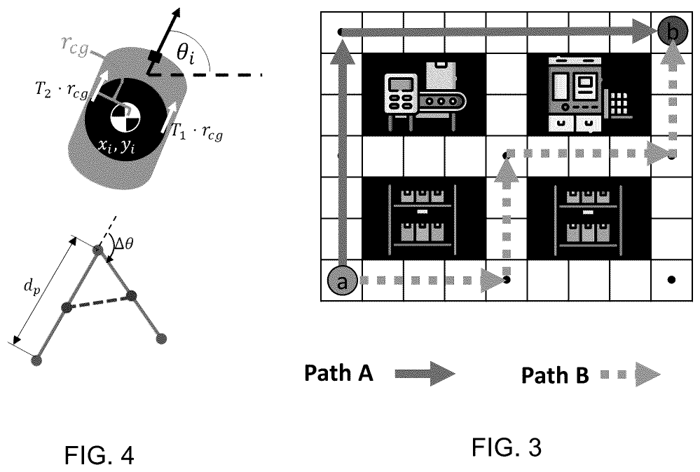

Referring to FIG. 3, the traversal cost and the pivoting cost associated with a robot navigating through consecutive waypoints is now explained. In the illustrative example of FIG. 3, path A and path B are two possible paths for a robot travelling from point (a) to point (b). The robot is oriented to head north in the travel direction of path A. The travel distance for path A or path B is the same and thus the traversal costs for path A and path B are the same. However, the robot needs to make one 90° turn for path A and four 90° turns for path B to travel from point (a) to point (b). More energy is used and more time is spent in changing direction of the robot for path B. Therefore, path B has a higher pivoting cost than path A.

The material flow throughput of a facility can be enhanced by reducing the time spent on travelling, turning, waiting and charging by the robot when navigating through the assigned sequence of waypoints. Therefore, an optimal path is the most efficient path that has least overall path cost including the traversal cost and the pivoting cost.

Referring to FIG. 4, to consider the pivoting cost more efficiently, a dual graph method is used. A dual graph is a method in space syntax that considers edges as nodes and nodes as edges. In road networks, large avenues made of several segments become signal nodes, while intersections with other avenues or streets become links (edges). The edges are weighted by the total cost of traversal and orientation changes. This method is useful for revealing hierarchical structures in a planar network. Based on a planar network such as urban streets (A), space syntax proposes to consider line segments differently from traditional graph theory, where links (edges) are streets and intersections are nodes (vertices). The optimal path with least overall cost can be obtained by numerous polynomial time algorithms such as the Dijkstra's algorithm, or the A* algorithm if an admissible heuristic exists.

In the illustrative example that has only two waypoints in FIG. 3, path A and path B each have a travel distance of 140 m. Path A requires one 90° turn, whereas path B requires four 90° turns. The power consumed is 214 kj for path A and 244 kj for path B, which is 14% more than path A. The time required is 87.2 seconds for path A, and 89.6 seconds for path B, which is 3% more than path A. Therefore, path B has higher total path cost than path A. These values are only for illustrative purposes and are not used to limit the scope of the present disclosure.

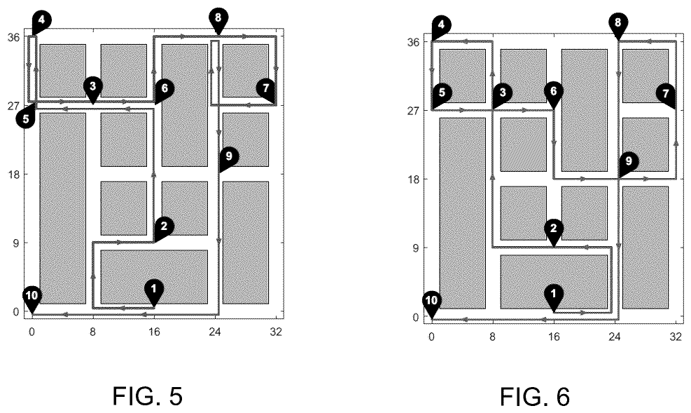

Referring to FIGS. 5 and 6, for a facility that has more than two waypoints, such as ten waypoints in the illustrative example, the optimal path (i.e., the path with the least total path costs) based on the dual graph method may depend on the number of waypoints being considered at a time. FIG. 5 shows an optimal path when only two consecutive waypoints are considered at a time. FIG. 6 shows an optimal path when all of the ten waypoints are considered at a time. Based on the dual graph analysis, the path in FIG. 6 can achieve 10% reduction in total path costs. It is understood that the value is only for illustrative purpose and is not used to limit the scope of the present disclosure. Therefore, to find an optimal path, the sequence of all the ten waypoints should be considered at a time.

For a multi-load mission, assuming that the path between consecutive waypoints is independent of other waypoints generates unnecessary constraints in robot orientation. This yields sub-optimal solutions, because the optimal path between waypoints is dependent on the robot orientation at each waypoint, which is unconstrained in the true problem.

The dual graph method can be used to find an optimal path for a multi-load robot through a sequence of spatial waypoints. The waypoint sequence representation is capable of accounting for time, energy, or any relevant cost associated with the robot moving through the environment. This includes vertex costs such as turn costs, wait time at intersections or when merging into higher traffic pathways. Depending on the environment waypoint sequence and cost function, a substantial reduction in path cost can be realized when compared with the approach of using only two waypoints at a time.

However, when the number of nodes in the waypoint sequence representation is huge, it may pose a computational problem if the sequence of all of the waypoints is considered at a time. A case study has shown that a staggered three waypoints method can be used instead. The staggered three waypoints method is an approximate method that can obtain near optimal paths by breaking the waypoint sequence problem into sub-problems that contain three consecutive waypoints. It has been determined that considering the waypoint sequence instead of just consecutive pairs of waypoints results in fewer and smaller turns. This is because the two waypoints method does not have the look-ahead capability of the staggered three waypoints or global approaches. The staggered three waypoints method scales much better than the global method. A case study has shown that path planning using three consecutive waypoints at a time is computationally more efficient and there is no optimality gap with the solution found considering all waypoints at a time, as shown in Table 1 below. The values are only for illustrative purposes and are not used to limit the scope of the present disclosure.

TABLE 1

| | Traversal cost | Turn cost | Total path cost |
|---|---|---|---|
| 2 waypoints at a time | 204 | 153 | 357 |
| Staggered 3 waypoints | 204 | 117 | 321 |
| All waypoints at a time | 204 | 117 | 321 |

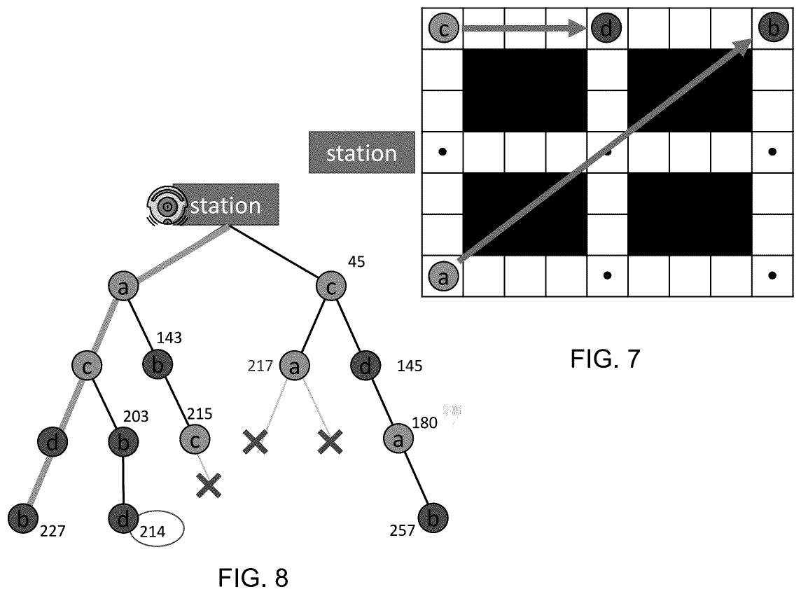

Referring to FIG. 7, after the total path costs of all possible paths are determined by the path planning module 32, this information is sent to the sequence determination module 34, which is configured to determine a sequence of the waypoints, taking movement constraints into consideration. In the illustrative example of FIG. 7, the path for a robot may include pickup points (a), (c) where materials are to be picked-up and drop-off points (b), (d) where the materials are to be dropped off. One or more of the pickup points must be visited before the fleet 24 of robots travels to the corresponding one or more of the drop-off points. Therefore, the sequence of some of the pickup locations and the drop-off locations pose a constraint on the path planning.

The sequence determination module 34 is configured to determine a path for a robot, taking these constraints into consideration, by using a Branch and Bound (B&B) algorithm. B&B is a method for solving optimization problems by breaking them down into smaller sub-problems and using a bounding function to eliminate sub-problems that cannot contain the optimal solution. B&B algorithms systematically partition the solution search space into subsets that are arranged in a tree structure. The root of the tree is the original problem and the leaves of the tree are individual candidate solutions to the original problem. Between the root and the leaves are intermediate nodes that represent subproblems obtained by recursively partitioning the original problem by a process called branching. The order according to which these subproblems are examined is determined by a best-first selection criteria that first explores the subproblem with lowest cost, i.e., exploitation.

For minimization problems, the upper bound is the incumbent solution defined as the most efficient candidate solution to the original problem found at the leaf node. The upper bound is continuously updated as the tree is explored, and is used to prune sub-optimal branches without recursively evaluating their solutions up to the leaf node. Thus, as the algorithm searches from the root to the leaves, branching is conducted only if the cost at the node is lower than the incumbent solution, and branching can potentially find a better solution than the incumbent solution. Following this process, the B&B algorithm recursively decomposes the original problem until further branching is futile when the solution cannot be improved, or until the original problem has been solved when every feasible branch has been evaluated.

Referring to FIG. 8 in conjunction with FIG. 7, as shown in the illustrative example, points (a) and (c) are the pickup locations and points (b) and (d) are drop-off locations and thus the robots must first travel to point (a) or point (c) to pick up items before traveling to point (b) or point (d) to drop off the items. Considering this constraint, a plurality of possible sequences are analyzed using the B&B algorithm. The B&B algorithm explores all possible sequences in the form of branches of a tree. For example, six possible sequences are shown. The first possible sequence is (a)->(c)-(d)->(b) having a total path cost of 227. The second possible sequence is (a)->(c)->(b)->(d) having a total path cost of 214. During exploring of the sequence, the upper and lower estimated bounds on the optimal solution are checked. Therefore, during exploring of the third possible sequence (a)->(b)->(c), before the fourth node (d) is explored, the path cost of 215 is checked against the lower estimated bound 214 of the second possible sequence. Since the third possible sequence cannot produce a better solution than the second possible sequence due to the higher total path cost, the third possible sequence is discarded. It is understood that if the initial path (i.e., the first possible sequence) evaluated is chosen well (i.e., with a relatively lower total path cost), more sequence branches can be cut earlier, thereby reducing the number of computations by the B&B algorithm.

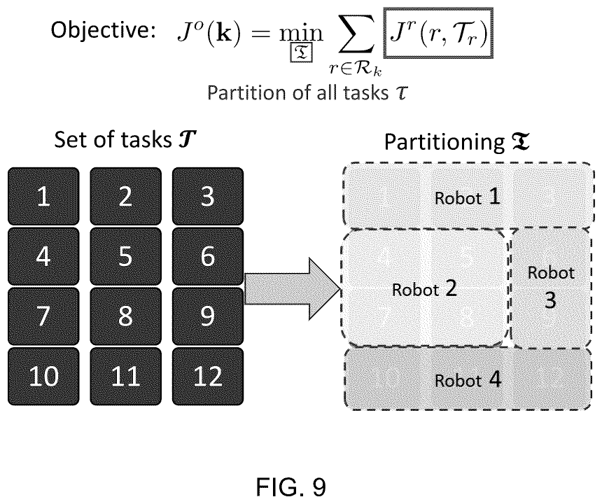

Referring to FIG. 9, after the sequence of waypoints to be visited by the fleet of robots 24 is determined, this information is sent to the task assignment module 36, which is configured to assign tasks to the fleet of robots 24. In the illustrative example, twelve tasks are to be assigned to a fleet of four robots.

Consider a manufacturing plant with a known layout that comprises various spatial constraints, and a set of material handling tasks [symbol] , each task involves picking-up certain cargo items at inventory locations and dropping them off at their designated drop-off locations within defined time windows. The objective of the optimization in this step is to find the optimal fleet of multi-load capacitated AMRs that completes all the defined tasks [symbol] while minimizing fixed and operational costs, as noted in the equation below:

$${J}^{O} ( k ) = {min}_{ℐ} {\sum }_{r ∈ {ℛ}_{k}} {J}^{r} ( r , {𝒯}_{r} ) \qquad Equation 1$$

wherein J⁰(k) is operational cost, J^{r}(r, [symbol] ) is the minimum operational cost, k is the number of robots in the fleet, Rₖ is the set of robots of type k, r is a robot in set Rₖ and [symbol] is the set of tasks assigned to a robot r.

The minimum operational cost J^{r} (r, Tᵣ) for each robot in fleet k is dependent on the AMR type, and is also affected by the sequence with which task locations are visited. This is because it is possible for the robot to pick up multiple items before dropping them off so long as each pickup is visited before the corresponding drop-off.

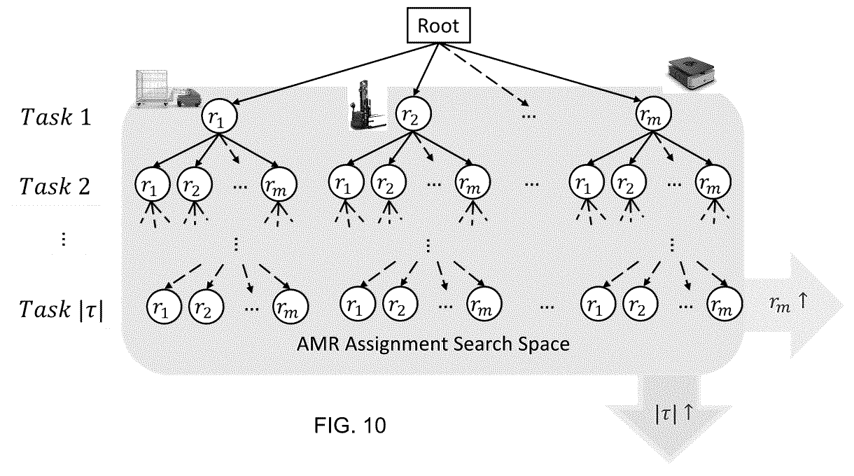

Referring to FIG. 10, the task assignment module 36 is configured to use the B&B algorithm to determine how the tasks are assigned to the robots. Determining the fleet composition and the task assigned to each robot is an N-P hard problem.

The fleet composition refers to the composition of the robots in the fleet, including the number of the robots (i.e., the size of the fleet) and the types of robots contained in the fleet 24. The fleet composition optimization involves determination of the fleet size as well as the type of AMR to be used. B&B algorithms are used for this NP-hard problem for an optimal solution.

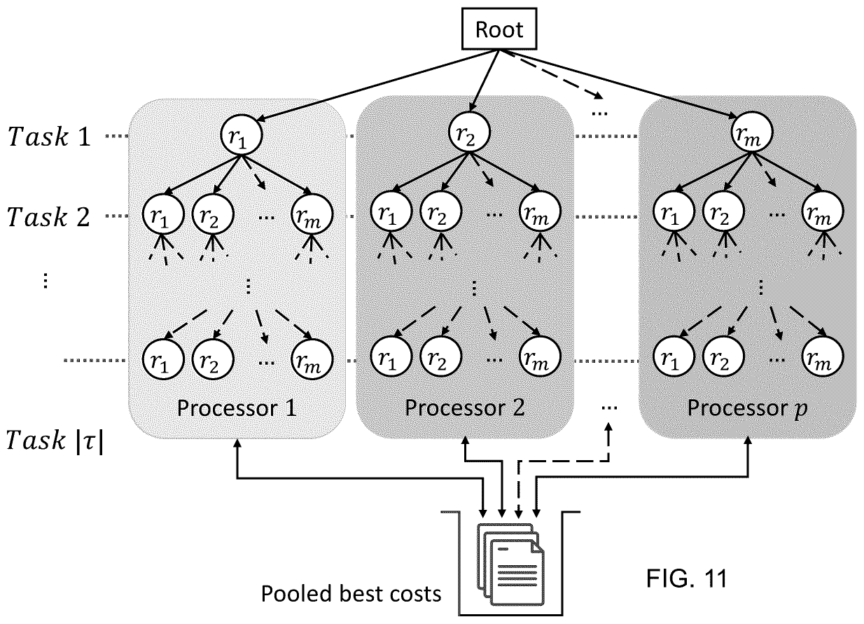

Referring to FIG. 11, to better trace the subproblem, the task assignment search space is partitioned between multiple computational processors including processor 1, processor 2, . . . processor p. Pooled best costs permit quicker branch pruning across the search space. The B&B algorithm of the NP-hard resource allocation problem is implemented in a parallel framework that uses p processing cores where robots in the fleet are identified by subscript r∈R: ={1, 2, . . . , m}. Thus, by splitting the arborescence at some task assignment level and assigning the emanating subtrees to the available processors, several subproblems are explored simultaneously. During each processor's exploration, updated incumbent solutions found are instantaneously made available to every processor in an asynchronous information sharing method using a shared work pool.

For each processor, the B&B algorithm is implemented by a recursive function to minimize memory and computational requirements as the tree is explored. Further, since the computation time of B&B algorithms increases with the number of feasible branches at each node, the fleet is initiated with a smaller candidate fleet than the maximal fleet. After evaluating the total cost of this candidate fleet, the number of robots is incrementally raised until further increments do not reduce the total cost or additional robots remain idle. For each fleet increment, only task assignment subproblems that include at least one of the newly added robots are evaluated, since other solutions are guaranteed to have been evaluated already.

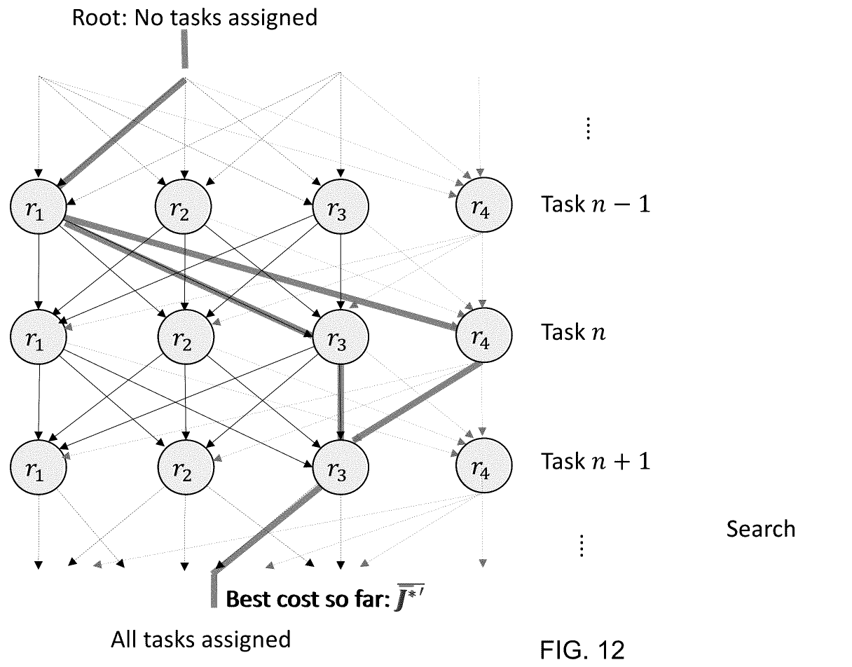

Referring to FIG. 12, after the task assignment module 36 determines the number of tasks to be performed by a robot and the number of robots contained in the fleet, the fleet planner module 38 then determines the fleet composition and the tasks performed by the fleet of robots. Instead of initializing the problem with the largest fleet size possible, the fleet planner module 38 starts with a smaller fleet and finds its cost J by solving the nested problem and then makes incremental additions to the fleet until further additions do not reduce the overall cost J. The optimal fleet size and composition problem is a nested optimization problem and may be solved by using the increment to stagnation algorithm. The objective of the overall algorithm is to find the smallest possible fleet that can complete all the tasks, while minimizing the operational cost. If the addition of a robot to the fleet does not increase the overall cost, then any larger fleet will lead to a suboptimal solution. There is no need to further explore the overall cost and then the algorithm can be stopped.

After an optimal fleet composition, an optimal task distribution among the robots, an optimal sequence of waypoints, and an optimal path through the sequence of waypoints are determined, the fleet selection and operation module 40 manages and controls the fleet of robots to move in the automated facility accordingly.

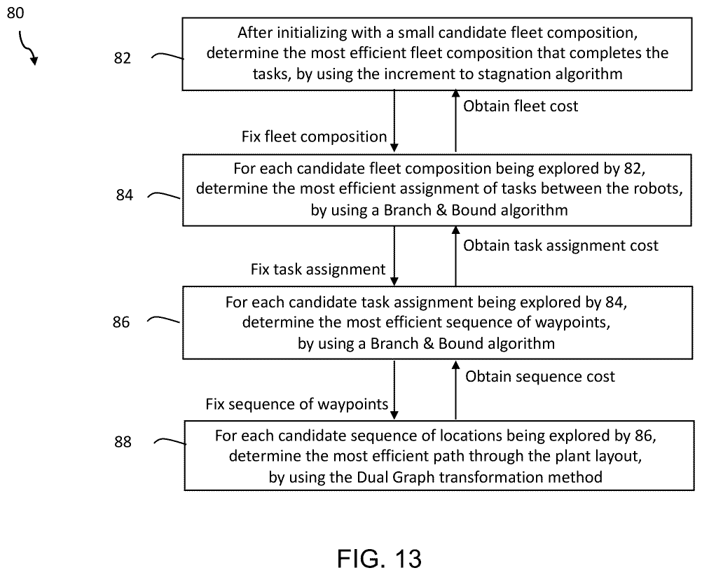

Referring to FIG. 13, a method 80 of managing a fleet of robots through a plurality of waypoints in a facility starts with initializing a small candidate fleet composition. After initializing with a small candidate fleet composition, the most efficient fleet composition (i.e., the fleet composition with the least cost) that completes the tasks is determined by using the increment to stagnation algorithm in step 82. For each candidate fleet composition being explored in step 82, the most efficient assignment of tasks (i.e., the assignment of tasks with the least cost) between the robots are determined by using a Branch and Bound algorithm in step 84. For each candidate task assignment being explored in step 84, the most efficient sequence of waypoints (i.e., the sequence of waypoints with the least cost) is determined by using a Branch and Bound algorithm in step 86. For each candidate sequence of locations being explored in step 86, the most efficient path through the plant layout is determined by using the dual graph transformation method in step 88. After the most efficient assignment of tasks, the most efficient sequence of waypoints, and the most efficient path are determined in steps 84, 86, and 88, respectively, the sequence cost, the task assignment task and the fleet cost can be determined.

In the fleet management system and method in accordance with the teachings of the present disclosure, multiple tools are used to manage and control deployment of AMR by: 1. selecting an optimal fleet composition; 2. determining optimal distribution of tasks within the selected fleet; 3. determining an optimal sequence of visiting waypoints once tasks have been assigned; and 4. determining an optimal path through the sequence of waypoints. With the fleet management and method of the present disclosure, the fleet of robots can handle material delivery more efficiently with least operational costs.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of managing a fleet of robots for delivery of materials in a facility, the method comprising:
determining a sequence of waypoints by a Branch and Bound (B&B) method;
determining a path through the sequence of waypoints by a dual graph method;
determining distribution of tasks among the robots by the B&B method; and
determining a fleet composition by the B&B method.

2. The method according to claim 1, further comprising determining a small candidate fleet composition having the most efficient fleet composition by using an increment to stagnation method.

3. The method according to claim 1, wherein the determining a path through the sequence of waypoints comprises determining a total path cost of the path.

4. The method according to claim 3, wherein the total path cost includes a traversal cost and a pivoting cost.

5. The method according to claim 4, wherein the traversal cost is a cost relating to translational movement of the fleet of robots.

6. The method according to claim 4, wherein the pivoting cost is a cost relating to changing direction of the robots and time spent on changing direction.

7. The method according to claim 1, wherein the determining a path through the sequence of waypoints comprises selecting a path that has the least total path cost.

8. The method according to claim 1, wherein the determining a sequence of waypoints comprises determining movement constraints.

9. The method according to claim 8, wherein the determining distribution of tasks among the robots comprises partitioning a search space for the assignment of tasks by using a plurality of processors.

10. The method according to claim 1, wherein the fleet composition includes a number of robots and types of robots in the fleet.

11. The method according to claim 1, wherein the fleet or robots include a plurality of autonomous mobile robots (AMRs).

12. The method according to claim 1, further comprising determining the sequence of the waypoints by considering staggered three waypoints at a time.

13. The method according to claim 1, wherein the waypoints include pickup locations and drop-off locations where the robots pick up and drop off items, respectively.

14. A method of managing a fleet of robots for delivery of materials in a facility, the method comprising:
determining a sequence of waypoints by a Branch and Bound (B&B) method based on movement constraints;
determining a path through the sequence of waypoints by a dual graph method based on a total path cost;
determining distribution of tasks among the robots by the B&B method; and
determining a fleet composition by the B&B method.

15. The method according to claim 14, further comprising determining the sequence of the waypoints by considering three staggered waypoints at a time.

16. The method according to claim 14, further comprising partitioning a search space for the assignment of tasks by using a plurality of processors.

17. The method according to claim 14, wherein the fleet composition includes a number of the robots and types of robots in the fleet.

18. The method according to claim 14, wherein the fleet or robots include a plurality of autonomous mobile robots (AMRs).

19. The method according to claim 14, wherein the determining a path through the waypoints based on a dual graph further comprises selecting a path that has the least total path cost.

20. The method according to claim 14, wherein the waypoints include pickup locations and drop-off locations where the robots pick up and drop off items, respectively.
